(19) United States
(12) Patent Application Publication
(10) Pub. No.: US 2009/0121402 A1
(43) Pub. Date: May 14, 2009

(54) SUSPENSION FOR A VEHICLE

(76) Inventors: James F. Ziech, Kalamazoo, MI (US); Michael L. Zebolsky, Marshall, MI (US)

Correspondence Address: MARSHALL & MELHORN, LLC;Attention: Stephen P. Evans, 8th Floor, Four Seagate, Toledo, OH, 43604, US

(21) Appl. No.: 11/937,030

(22) Filed: Nov. 8, 2007

(51) Int. Cl. B60G 13/10; F16F 5/00

(52) U.S. Cl. 267/217; 267/64.11

(57) ABSTRACT

A suspension for a vehicle having a lower bracket secured to an axle housing. An air bag spring is cantilevered from the lower bracket. A shock absorber and a lower control arm are connected to the lower bracket. An upper bracket is secured to the axle housing. The upper bracket has two upwardly extending arms. An anti-roll bar and an upper control arm are pivotally connected to the upper bracket between said upwardly extending arms.

### FIELD OF THE INVENTION

The present invention relates to a suspension for a vehicle. More particularly, the invention relates to a rear, parallelogram suspension for a vehicle.

### BACKGROUND OF THE INVENTION

Vehicle suspensions are well-known, but suffer from a variety of problems which have not yet been solved by the known prior art. For example, reliability is often a problem with the known suspensions, particularly with air bag springs. Furthermore, air bag springs add cost and weight to a vehicle. Thus, to the extent that the number of air bag springs can be reduced, the reliability of the suspension may be increased while the cost and weight can be minimized.

Also, some suspensions do nothing to, or are ineffective, at reducing noise, vibration and harshness issues often associated with vehicles, and in particular their drivelines. Thus, it would be desirable for a suspension to help minimize noises vibration and harshness of a vehicle.

Further, many suspensions are not only in tension and compression but also must deal with bending. When subjected to bending loads, the suspensions must be more robust, thus making them more expensive and heavier. It would also therefore be desirable to limit the loads experienced by a suspension to tension/compression loads.

Many suspensions also suffer from an inability to resist rolling of the vehicle. It would be desirable to provide a suspension, addressing all of the other concerns above, with an anti-roll device which permitted the suspension to be easily tunable to a predetermined roll characteristic and/or use “smart” active anti-roll systems.

### SUMMARY OF THE INVENTION

A suspension for a vehicle may have a lower bracket secured to an axle housing. The lower bracket may have a forward portion and a trailing portion. The trailing portion may cantilever an air bag spring behind the axle housing. A shock absorber may be pivotally connected to the forward portion of the lower bracket. A lower control arm may be pivotally connected to the lower bracket. An upper bracket may be secured to the axle housing. The upper bracket may have two upwardly extending arms. An anti-roll bar may be pivotally connected to the upper bracket. An upper control arm may also be pivotally connected to the upper bracket.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a partial schematic plan view of one half of a suspension of the present invention;

FIG. 2 is a partial schematic cut-away side view of the suspension of FIG. 1; and

FIG. 3 is a partial schematic view of the suspension of FIGS. 1 and 2 as the suspension would appear looking from the rear of a vehicle forward.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

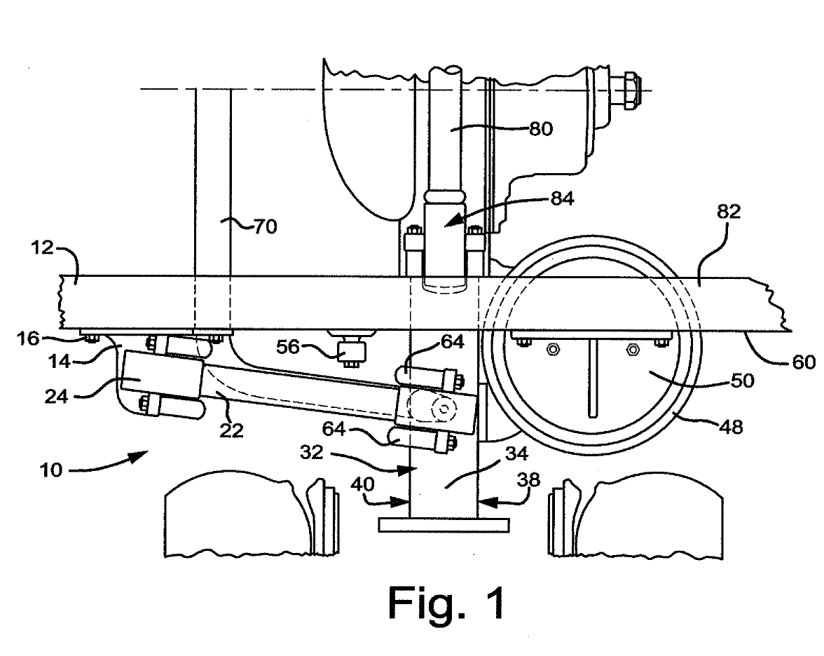

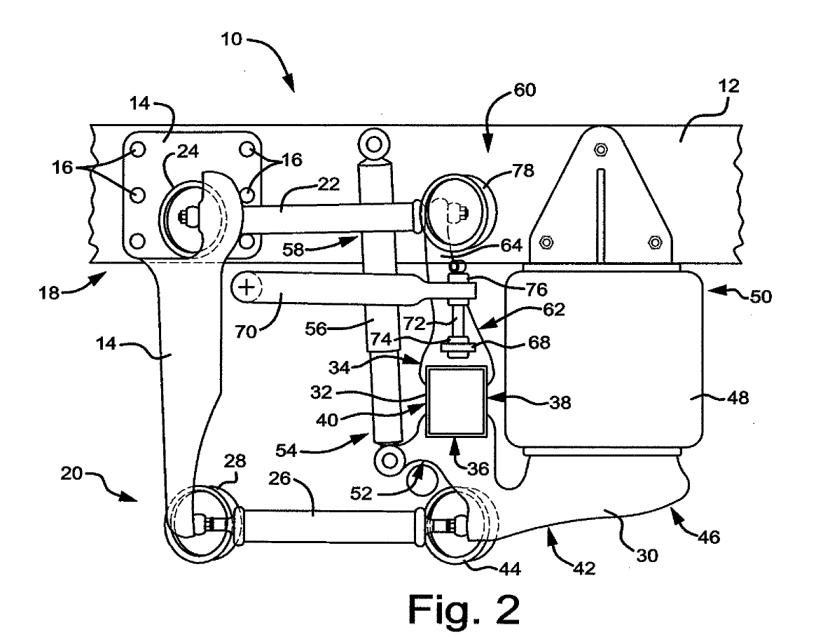

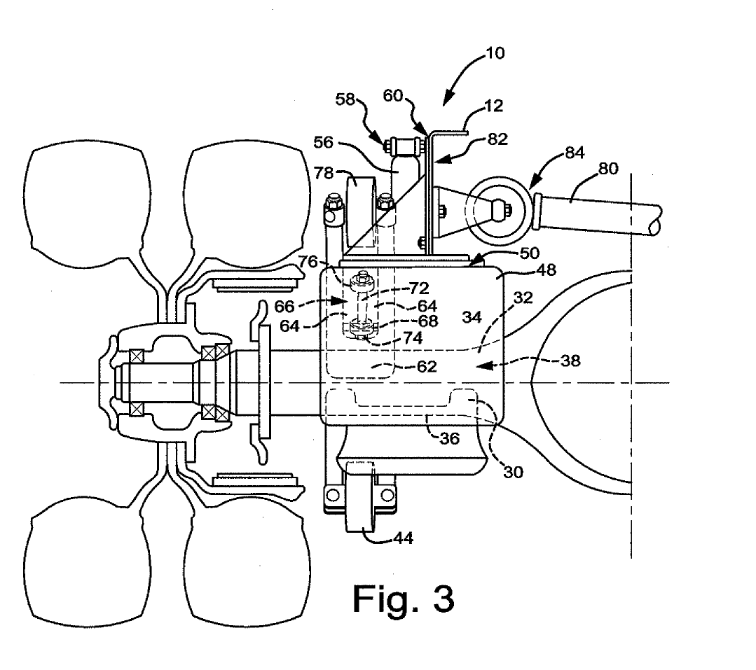

Looking now at FIGS. 1-3 a suspension system 10 for a vehicle is schematically depicted. FIGS. 1-3 depict one side of a vehicle; it can be readily appreciated that the structures depicted in FIGS. 1-3 and discussed below are substantially identical to those that are on the other side of the vehicle (except track rod 80 discussed below).

The suspension system 10 of FIGS. 1-3 is depicted for a rear engine vehicle. Those skilled in the art will readily appreciate however the fact that the suspension system 10 can be used with front or rear engine vehicles.

A chassis frame member 12, such as a C-shaped member, is provided. A chassis attachment bracket 14 is attached to the chassis frame member 12. The bracket 14 may be attached to the chassis frame member 12 with a plurality of mechanical fasteners 16, such as nuts and bolts. The chassis attachment bracket 14 extends generally downward from, and may be substantially perpendicular to, the chassis frame member 12.

An upper portion 18 of the chassis attachment bracket 14 defines a generally V-shaped portion. A lower portion 20 of the chassis attachment 14 bracket also defines a generally V-shaped portion.

An upper control rod 22 is pivotally attached, such as via a bushing 24, between the components of the chassis attachment bracket 14 forming the upper V-shape 18. A lower control rod 26 is pivotally attached, such as via a bushing 28, between the components of the chassis attachment bracket 14 forming the lower V-shape 20. Both control rods 22, 26 extend generally rearward and generally parallel to one another.

The lower control rod 26 is pivotally attached to a unitary lower bracket 30 that is located on the underside of an axle housing 32. The axle housing 32 may have a square cross section thus defining an upper portion 34, a lower portion 36, a rearward portion 38 and a forward portion 40. Preferably, the lower bracket 30 extends across the lower portion 36 and then upwardly where it extends partially along the rearward portion 38 and the forward portion 40. The lower bracket 30 is welded at least where the rearward portion 38 and the forward portion 40 terminate with the axle housing 32.

The lower bracket 30 has a lowermost portion 42 for pivotally receiving the lower control rod 26 via a bushing 44. The lowermost portion 42 may have a V-shape for receiving the bushing 44 and control rod 26 therein.

Extending upwardly and rearwardly from the lowermost portion 42 is a rearward portion 46 of the lower bracket 30. The rearward portion 46 of the lower bracket 30 is cantilevered off the back of the bracket 30 and thus the axle housing 32. No structure is located between and connecting the rearward portion 46 of the lower bracket 30 on one side of the axle housing 32 and a similarly situated rearward portion of the lower bracket on the other side of the axle (not shown).

An air bag spring 48 is connected to the rearward portion 46 of the lower bracket 30. More specifically, the air bag spring 48 sits atop of the rearward portion 46. The air bag spring 48 is connected at its upper portion 50 to the chassis frame member 12. The air bag spring 48 resides entirely behind the axle housing 32.

The lower bracket 30 has a forward extending portion 52. This portion 52 pivotally receives the lower portion 54 of a shock absorber 56. The upper portion 58 of the shock absorber 56 is pivotally connected to an outboard surface 60 of the chassis frame member 12. As connected, the shock absorber 56 is located outboard of the frame member 12.

A unitary upper bracket 62 is attached to the axle housing 32. Preferably, the upper bracket 62 extends across the upper portion 34 of the housing 32 where it extends downwardly along the rearward portion 38 and the forward portion 40. The upper bracket 62 is welded at least where the rearward portion 38 and the forward portion 40 terminate with the axle housing 32.

The upper bracket 62 comprises two upstanding arms 64 defining a gap 66 between them. The arms 64 are unitary with the rest of the bracket 62 and they extend substantially directly above the axle housing 32. A flange 68 extends across the gap 66 and it is connected to both arms 64. An anti-roll bar 70 is pivotally attached to the flange 68. More specifically, a shaft 72 having a lower bushing 74 and an upper bushing 76 is provided. The lower bushing 74 is pivotally mounted with the flange 68. The anti-roll bar 70 is pivotally connected to the upper bushing 76.

The anti-roll bar 70 extends forward from the upper bracket 62 outboard from the shock absorber 56. Adjacent, but rearward of, the chassis attachment bracket 14, it extends beneath the chassis frame member 12 where it extends substantially parallel the axle housing 32 to the other side of the vehicle. As will be appreciated by those skilled in the art, the anti-roll bar 70 adds roll stiffness to the suspension system 10. It may be tunable to a desired roll characteristic and it may be coupled with “smart” active anti-roll systems.

Above the flange 68, the upper control rod 22 is pivotally connected to the upper bracket 62, such as by a bushing 78. More specifically, the upper control rod 22 is mounted to and located between the two upstanding arms 64. The upper control rod 22 extends forward from the bracket 62 where it is pivotally connected to the chassis attachment bracket 14. The upper control rod 22 is positioned above the anti-roll bar 70.

A track rod 80, also known as a panhard rod, may be connected on an inboard surface 82 of the chassis frame member 12. More specifically, one end 84 of the rod 80 may be pivotally attached to the chassis frame member 12 approximately above the axle housing 32. A second end of the rod (not shown) may be attached to the axle housing 32. The rod 80 provides lateral stability to the suspension system 10.

As can be appreciated by the foregoing and the accompanying figures, the suspension linkage members comprising the upper and lower rods 20, 22 are subject only to tension or compression loads, not bending loads. Thus, the rods 20, 22 may be light weight tubular-type members; heavy cross sections are not required.

It may also be appreciated that braking forces tend to reduce loads experienced at points where the rods 20, 22 connect to other structures. Thus, elastomeric type bushings may be used.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A suspension for a vehicle, comprising:
a chassis frame member;
a chassis attachment bracket having an upper portion and a lower portion, said upper portion being secured to said chassis frame member;
an upper control rod pivotally connected to said upper portion of said chassis attachment bracket;
a lower control rod pivotally connected to said lower portion of said chassis attachment bracket;
an axle housing having a forward portion, a rearward portion, an upper portion and a lower portion;
a lower bracket located partially about said lower portion of said axle housing, said lower control rod being pivotally connected to said lower bracket, said lower bracket having a forward extending portion and a rearward extending portion;
an air bag spring cantilevered off said rearward portion of said axle housing with said rearward extending portion of said lower bracket, said air bag spring being connected to said chassis frame member;
an upper bracket located partially about said upper portion of said axle housing, said upper control rod being pivotally attached to said upper bracket; and
an anti-roll bar connected to said upper bracket below said upper control rod.

2. The suspension of claim 1, wherein a lower portion of a shock absorber is pivotally attached to said forward extending portion of said lower bracket.

3. The suspension of claim 2, wherein an upper portion of said shock absorber is pivotally attached to an outboard surface of said chassis frame member.

4. The suspension of claim 4, wherein said shock absorber is located outboard of said chassis frame member.

5. The suspension of claim 1, wherein said lower bracket is unitary.

6. The suspension of claim 1, wherein said upper bracket comprises two upwardly extending arms, said anti-roll bar being pivotally mounted between said two arms.

7. The suspension of claim 6, wherein said upper control rod is pivotally mounted between said two arms of said upper bracket.

8. A suspension for a vehicle, comprising:
an axle housing;
a lower unitary bracket located partially about a lower portion of said axle housing, said lower bracket comprising a forward portion and a rearward portion, said rearward portion cantilevering an air bag spring behind said axle housing;
a shock absorber pivotally connected to said forward portion of said lower bracket;
a lower control rod pivotally connected to said lower bracket;
a unitary upper bracket located partially about an upper portion of said axle housing, said upper bracket having two upwardly extending arms;
an anti-roll bar pivotally connected to said upper bracket between said upwardly extending arms; and
an upper control rod pivotally connected between said upwardly extending arms above said anti-roll bar.

9. The suspension of claim 8, wherein said air bag spring is also connected to a chassis frame member located above said air bag.

10. The suspension of claim 9, wherein said shock absorber is also connected to an outboard surface of said chassis frame member.

11. The suspension of claim 8, wherein said lower control rod is also pivotally connected to a chassis attachment bracket forward of said axle housing

12. The suspension of claim 1, wherein said anti-roll bar extends from said upper bracket outboard of said shock absorber and below said upper control rod before extending inboard rearward of said chassis attachment bracket.

13. The suspension of claim 12, wherein said upper control rod is pivotally connected to said chassis attachment bracket.

14. A suspension for a vehicle, comprising:
a chassis frame member located above an axle housing;
an air bag spring cantilevered from a rearward portion of a lower bracket located partially about said axle housing, said air bag spring connected to said chassis frame member;
a shock absorber having one portion connected to a forward portion of said lower bracket and the other portion connected to said chassis frame member; and
an upper bracket located partially about said axle housing, said upper bracket defining two upstanding arms wherein an anti-roll bar and an upper control rod are pivotally mounted between said arms; and
a chassis attachment bracket to which said upper control rod and a lower control rod are attached, said lower control rod pivotally connected to said lower bracket.

15. The suspension of claim 14, wherein said chassis frame member has an inboard portion and an outboard portion, wherein a track rod is pivotally attached to said inboard portion and said shock absorber is attached to said outboard portion.

16. The suspension of claim 14, wherein said upper control rod and said lower control rod are tension or compression members and not subject to bending loads.

17. The suspension of claim 14, wherein only a single air spring bag is located between a differential housing and a wheel mounted at an end portion of said axle housing.
